(19) United States
(12) Patent Application Publication
(10) Pub. No.: US 2009/0234697 A1
(43) Pub. Date: Sep. 17, 2009

(54) Career development system

(76) Inventor: Ichirou Taguchi, Saitama-ken (JP)

Correspondence Address: JORDAN AND HAMBURG LLP, 122 EAST 42ND STREET, SUITE 4000, NEW YORK, NY, 10168, US

(21) Appl. No.: 11/886,015

(22) PCT Filed: Mar. 11, 2005
(86) PCT No.: PCT/JP2005/004283

§ 371 Date: Jun. 16, 2008

(51) Int. Cl. G06Q 10/00

(52) U.S. Cl. 705/9

(57) ABSTRACT

A carrier development system wherein registrant communication terminals carried by registrants, an employer end communication terminal, and a system server computer are mutually connected via a communication network such as the Internet, and wherein the computer automatically assigns the registrants, who satisfy employment requirements of an employer end, to time frames (cells) corresponding to job types on each day. A shift creation window, in which the cells are arranged in accordance with cell assignment conditions, is used to automatically assign the registrants to the cells, based on personnel assignment conditions and the preset values of work performance appraisal related to the registrants. The shifts of the respective job types are made open such that they can be viewed via the registrant communication terminals, thereby recruiting for some time interval. Thereafter, notifications of preliminary confirmations are transmitted to the registrant communication terminals of the assigned registrants through the communication network, and responses to the notifications are accepted via those registrant communication terminals. Then, applicants are automatically assigned to the cells in accordance with the employment requirements and the preset values of work performance appraisal, thereby creating a shift table.

### BACKGROUND OF THE INVENTION

The present invention relates to a career development system wherein a registrant communication terminal carried by a registrant, an employer-end communication terminal and a system server computer are connected via a communication network such as the Internet, and persons who satisfy work requirements of the employer are assigned automatically; more specifically, it relates to a career development system that, in a for shift system work mode for working people as part-timers or temporary workers, enables optimal placement (shift) of registrants to be executed automatically in accordance with capability based on performance evaluation while improving job awareness of the persons using shift system work.

Conventionally, when hiring temporary workers, etc. (hereinafter “short-term workers”), the capability of persons to be hired was determined though interviews, etc., and thereafter the workers were trained as they were engaged in their work, using training manuals and through on-the-job training.

Known conventional systems include a career counseling system that uses a work aptitude and ability development system and advises individuals of appropriate additional training curriculum depending on an individual's career history; a system that supports the appropriate selection of personnel for use in situations where the job skills needed by a company dramatically change every few years, such as in the information and communication industry or venture companies; and a personnel selection support system that uses a job aptitude and ability development system that enables an employer to determine to what extent appropriate additional training curriculum is needed depending on the individual career histories of jobseekers.

However, with the above conventional training emphasis was placed on ensuring that how the short-term workers worked did not interfere with work, the work of short-term workers had a strong supplemental nature, and it was difficult to consider such workers as a positive company asset.

In particular, the issue in terms of capability of workers in the service industry (retail industry, restaurant industry, etc.) was how can short-term workers be made into a more valuable asset, and to that end, making the capability of short-term workers equal to or greater than that of full-time employees was essential, and for that reason a capability development system was in demand that could ensure that short-term workers smoothly and reliably developed and retained such capability. Patent document 1 and patent document 2 have made proposals to such effect, but these types of systems cannot resolve the above problems.

At a workplace that employs short-term workers, a person in charge of staff management, for example, a manager of a family restaurant, considers the work requests of his or her staff and possible time blocks, and thus a shift-system work mode is employed using the conventional method of assigning time blocks to set persons.

However, various problems arise with the above method; one such issue is losses caused by sudden staff absences due to the low awareness that short-term workers have with respect to work. A two-fold loss ensues because not only is staff absent, but the person in charge must also take time to arrange replacement staff. Up to now, the countermeasure to this has been to anticipate personnel shortages and ensure a fixed staff; thus the reality has been that personnel costs exert pressure on profits.

At the workplace, management of short-term workers required the commitment of time, and handling this was a struggle; it was said that strategic personnel management was the method for resolving this issue.

In this shift work mode, when a replacement had to be arranged due to unexpected circumstances of persons scheduled to work, first, replacement persons to fill in were searched for and then contact with these replacements were made; and this work was repeated as necessary.

Further, confirmation had to be made one by one regarding whether the replacements found were able to work, and finally a request needs to be made to registrants to work, meaning that an extremely laborious and time-consuming process was required.

Further, when a sudden absence occurred, an employer had to stop normal work and spend time and effort in arranging for a replacement; for a registrant, even if he or she was suddenly absent, the matter ended with a simple notification to the employer, and the employer was unable to hold the registrant responsible for his or her absence.

Further, in a conventional shift-system work mode, “times are assigned to people”, in other words, “when assigning shifts, no consideration whatsoever is given to the duties a registrant can handle or the necessary capabilities”; thus, in other words, this ends up being merely a matter of trying to get the right number of people.

Furthermore, when shifts are assigned, complicated factors such as the capability of a registrant or tasks for which a registrant might be suited are left to the determination of the employer (company), leading to the problem that work efficiency would vary depending on ability of the employer to make assignments.

As described above, because “time was assigned to people”, that is, time and work were assigned on a registrant-by-registrant basis, once a registrant changed positions, quit or was absent, the entire shift had to be changed.

Patent document 1: JP 2003-331093 A

Patent document 2: JP 2003-6391 A

### SUMMARY OF THE INVENTION

The object of the present invention is to provide a career development system wherein a company evaluates the capabilities of persons registered to engage in shift-system work based on work performance, optimal placements (shifts) of persons registered or re-placements (shift changes) entailing shift changes are executed automatically based on such evaluation, and work awareness on the part of shift-system registrants is promoted.

The present invention is a career development system in which a registrant communication terminal carried by a registrant, an employer-end communication terminal, and a system server computer are connected via a communication network such as the Internet and the system server computer automatically assigns persons satisfying conditions for employment in time blocks (cells) corresponding to each duty on a day-to-day basis, such system server computer comprising storage means for storing employment requirements such as the number of persons being recruited, work period, work time blocks, and duties presented by an employer, as well as for storing persons who have registered in advance and such persons' prior work evaluation values; cell assignment conditions input means for registering requirements for a cell; personnel assignment conditions input means for setting at least employment type; shift frame creation means for specifying and entering a work period in order to create shifts corresponding to the employment requirements; cell creation means for adding created cells to shifts, having a cell creation screen for inputting cell conditions such as time block, number of people, position, employment form, and range of work evaluation values for each duty for each day of a work period registered in a shift frame created by shift frame creation means, shift creation means for automatically assigning persons to cells corresponding to each duty of each day based on a person's prior work evaluation value and personnel assignment conditions, shift creation means for automatically assigning persons to cells made to correspond to each duty for each day based on personnel assignment conditions and work evaluation data relating to such persons, and having a shift creation screen in which cells for each duty created for each of a work period by cell creation means are arranged in accordance with the set cell assignment conditions; entry means for, after the cells for each duty in accordance with each day of a work period have been created by shift creation means, posting shifts for each duty via a registrant's registered communication terminal and recruiting for a fixed period; and shift advance confirmation means for communicating to a person given an assignment by shift creation means an advance confirmation response via the registrant's terminal through a communications network and for receiving an advance confirmation response from the assigned person via the registrant's communication terminal, wherein, after the deadline for recruitment of a specific period set by entry means, shift creation means automatically assigns to the cell a person recruited based on a prior work evaluation value relating to person recruited and employment requirements.

Shift creation means has the following functions.

(1) Make assignments starting with persons who satisfy requirements with a high priority order registered in cells set by cell assignment condition input means.

(2) In those cells having a high assignment priority order from among the cells set by cell assignment condition means, make assignments starting with persons who satisfy requirements with a high priority order registered in such cells.

(3) This is priority order for shifts in accordance with the urgency and importance of the duty. Further, cell requirement priority order is in the order of the highest work evaluation value first.

(4) If there is overlap of a plurality of persons in the same cell, persons are assigned in the order of highest work evaluation value.

(5) Storing means stores reservation patterns agreed upon by staff and employer in which employment requirements under which work is possible are entered in advance, and when the condition for assigning personnel is first come, first served, shift creation means applies an entered reservation pattern stored in storing means to a cell and makes automatic assignments in priority order.

(6) When, after cells for each duty are created by cell creation means, a reservation pattern is applied and priority cells are designated, shift creation means makes automatic assignment of reservation patterns to cells in priority order, and after pre-posting shift finalization, entry means post shifts by duty to registrants via their registered communication terminal and recruits staff for a set period.

(7) If an open cell arises following automatic assignment of registered persons by shift creation means, entry means posts a shift for the duty of the open cell to those registered persons who have not been automatically assigned, and recruits again for a set period; after the deadline, shift creation means automatically assigns applicants to the empty cells based on advance work evaluation values of the applicants and employment requirements.

Another invention is a career development system in which a registrant communication terminal carried by a registrant, an employer-end communication terminal, and a system server computer are connected via a communication network such as the Internet, and the system server computer posts duties with employment requirements that the employer has presented, such as the number of persons to recruit, work period, work time blocks, and duties, to registrants' communication terminals, recruitment is carried out for a set time and, after the recruitment period deadline, automatic assignment is made of applicants to time blocks (cells) corresponding to each duty for each day based on advance work performance evaluation values relating to the applicants and the employment requirements, such system server computer comprising cell assignment condition input means for registering cell requirements and setting the priority order of the registered requirements, personnel assignment condition input means for setting at least the employment type order; shift frame creation means for designating and registering a work period in order to create shifts matching the employment requirements; cell creation means for adding created cells to shifts, having a cell creation screen for inputting cell conditions such as time block, number of people, employment type, and range of work performance evaluation values for each duty of each day of a work period registered in a shift frame created by shift frame creation means; shift creation means for automatically assigning persons to cells in accordance with the set cell assignment conditions, having a shift creation screen in which cells for each duty created for each day of a work period by cell creation means are arranged in accordance with the set cell assignment conditions; and shift advance confirmation means for notifying persons assigned by shift creation means of an advance confirmation response of a duty to the applicant's communication terminal via a communications network, and for receiving an advance confirmation response via the registrant's communication terminal from the assigned person.

The above means have the following functions.

When advance confirmation means receives communication from an assigned person, through an advance confirmation response, of an application for a change to a substitute person that the assigned person found himself (community shift change), shift creation means compares the advance work performance evaluation value relating to the substitute person with the work performance evaluation value set by the cell conditions, and determines whether the person is appropriate.

If shift advance confirmation means determines that none of the assigned persons sent an advance confirmation response, shift creation means, in accordance with personnel assignment conditions, makes automatic assignment of another person to the relevant cell (system shift change), and shift confirmation means notifies such other person of the assignment through such person's registrant communication terminal.

This invention exhibits the excellent effect of, for registrants working part-time jobs in service industries (retail, restaurant industry, etc.), making their capabilities equal to or greater than full-time employees; thus making it possible for companies that hire staff for part-time jobs, employing companies that are employers, or temporary staff agencies, subcontractors and job placement services to expect a major boost in their competitive strength.

According to the present invention, an employer can ascertain in advance absence and tardiness of registrants, and prevent in advance the discovery of an absence on the day of work or immediately prior thereto, enabling such matters to be addressed in advance at an early stage.

According to the present invention, for a registrant, an environment and awareness are formed such that it is psychologically difficult to be absent because indication of intent to be absent and confirmation thereof is linked to one's evaluation, a sense of personal responsibility with respect to work can be developed, and an improved job awareness on the part of the registrant occurs automatically through the management of the shift-system work mode.

According to the present invention, personnel is managed from the perspective of “assigning registrants to duties”, and time and responsibilities are assigned for each duty, and even if a registrant is reassigned, quits, is absent, etc., it is not necessary to change shifts overall nor it is necessary for the employer to possess sophisticated shift creating capabilities.

Because a registrant will seek replacements for himself through his own personal relationships, the present invention is also useful in ensuring that communication is treated as an important matter on a daily basis and in assisting with human development capable of relationships of trust.

### BRIEF DESCRIPTION OF THE DRAWINGS

FIG. 1 is a configuration diagram of a career development system of the present application.

FIG. 2 is an explanatory diagram showing the basic flow of shift creation.

FIG. 3 is a diagram showing an example of a shift table for which automatic staff assignment has been completed.

FIG. 4 is a diagram showing an example of a cell condition master.

FIG. 5 is a diagram showing a setting screen of a cell assignment condition master.

FIG. 6 is a diagram showing a setting screen of a personnel assignment condition master.

FIG. 7 is a diagram showing an input screen for shift creation.

FIG. 8 is a diagram showing a processing sorting screen for creating a shift frame.

FIG. 9 is a diagram showing a shift calendar.

FIG. 10 is a diagram showing a monthly template assignment screen.

FIG. 11 is a diagram showing a weekly template assignment screen.

FIG. 12 is a diagram showing a cell creation screen.

FIG. 13 is a diagram showing a reservation staff search screen.

FIG. 14 is a screen showing a reserved staff list screen.

FIG. 15 is a screen showing a final staff list screen.

FIG. 16 is a diagram showing a copy screen.

FIG. 17 is a diagram showing a day-of-the-week template assignment screen.

FIG. 18 is a diagram showing a day-of-the-week template assignment screen.

FIG. 19A is a diagram showing the system flow of an embodiment of the present invention.

FIG. 19B is a diagram showing the system flow continued from FIG. 19A.

FIG. 19C is a diagram showing the system flow continued from FIG. 19B.

FIG. 20 is an explanatory diagram of advance confirmation of the present system.

FIG. 21 is a flow diagram when a plurality of staff satisfying the employee input conditions are assigned.

FIG. 22 is a flow diagram for when a shift change occurs.

FIG. 23A is an explanatory diagram of a method for assigning starting from cells with a small number of reservations

FIG. 23B is an explanatory diagram continued from FIG. 3.

FIG. 24 is an explanatory diagram of another cell assignment method.

FIG. 25 is a diagram showing an example of an attendance evaluation.

### DETAILED DESCRIPTION OF THE INVENTION

Embodiments of the present invention will be explained with reference to the drawings.

### Embodiment 1

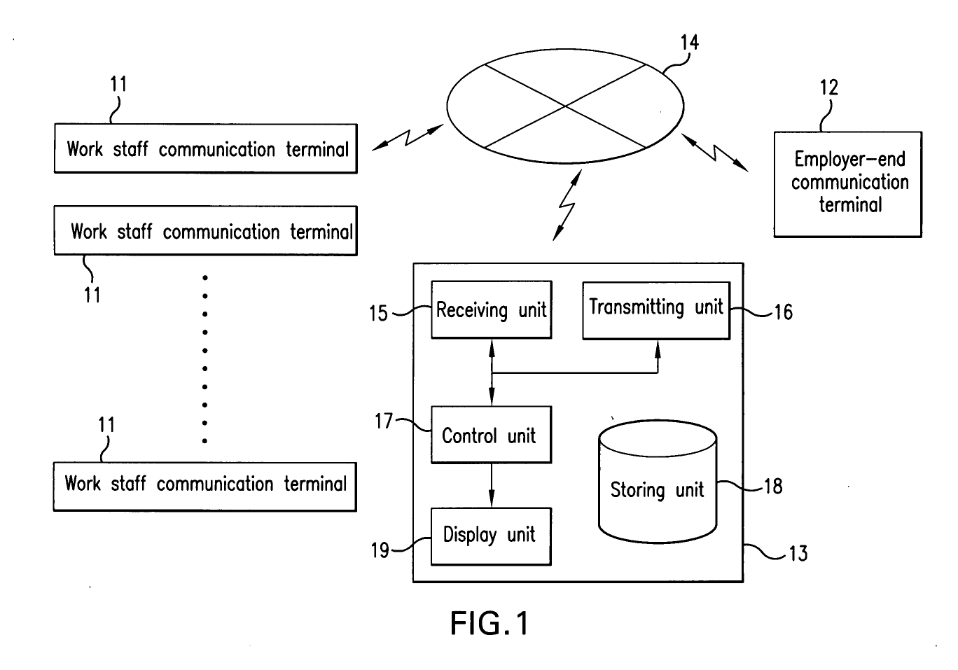

FIG. 1 is a configuration diagram of a career development system of the present application.

The present system is configured such that a registrant (work staff) communication terminal 11, employer side communication terminal 12 and system server computer 13 are connected via a communication network 14 such as the Internet, and transmission and reception of data thereamong is possible. Each registrant communication terminal is a personal computer or a portable communication terminal such as a mobile telephone. An employer side communication terminal 12 is a personal computer or a portable communication terminal such as a mobile telephone.

The server 13 comprises a transmission unit 16, a control unit 17 such as a CPU, a storing unit 18 such as a hard disk and a display unit 19 such as a display.

The control unit 17 has a shift function for assigning work and making changes to such assignments, a cell function for creating a work time block (cell), and stores a program for executing these functions; by starting this program, the intention of persons entered in the present system (hereinafter “staff”) to come to work is confirmed in advance through communications with a portable registrant communication terminal of such persons, and after determination is made of whether an absence is to be filled and the necessary filling-in is made, attendance evaluation data based on staff work performance and work intention confirmation and the like is read from the memory unit 18, and based on the work evaluation, work assignments are made, a shift table is created and finalized; in addition, the control unit 18 stores attendance evaluation data for each staff member, and the attendance evaluation data for each staff, created after working, is stored in the memory unit 18.

Means for resolving the problem addressed by the present invention are realized by executing the above program.

A cell condition master, cell assignment condition master, and personnel assignment condition master in which the data necessary for realizing shift functions and cell functions are used.

The object of automatic assignment is to resolve such issues as imbalance caused by having excellent staff being grouped together on earlier dates, by setting a priority order for staff to be assigned and a priority order for cells to be assigned.

Date and time assignment conditions set cell assignment order, and the items that can be set are date order, day-of-the-week priority, date priority, time priority and date cycle order.

In this embodiment, the order of cell assignments and personnel assignments is determined as follows.
Assignments are made only from staff satisfying cell conditions.
A cell may be affixed with a “priority” mark, and if there is a cell with a “priority” mark, after assignment in accordance with assignment priority condition order set within the “priority” cell, assignment is carried out in the cell assignment priority condition order set in the remaining cells.
Cell conditions are provided with essential conditions (items), and if there are no matches under such conditions after assignment has been made, assignment is made again using only the essential conditions. If there is still no match, the cell is left empty.
Possible staff work patterns include a time block for days or the week (if no time is set, the full day)—for example, Monday, Wednesday, Friday, 9:00 am to 5:00 pm, etc.
If a cell assignment priority has not been set, assignment is made in ascending order of cell date and time in duty order (from upper left to lower right of cells on the shift table). If personnel assignment priority has been set, assignment in ascending order of staff ID is made of days on which such staff can work.

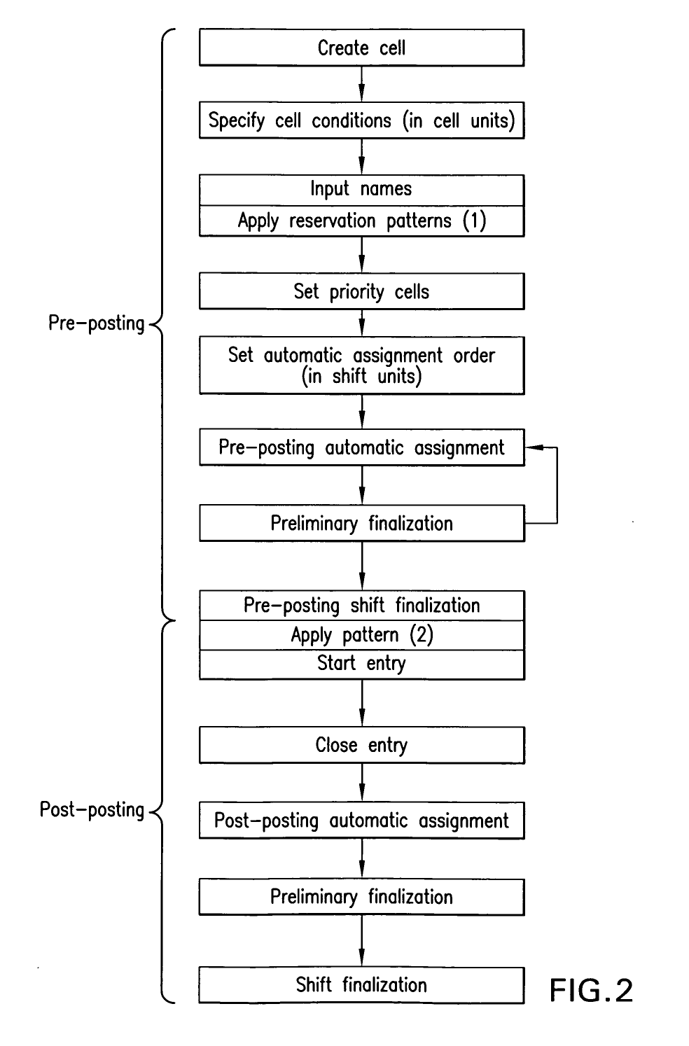

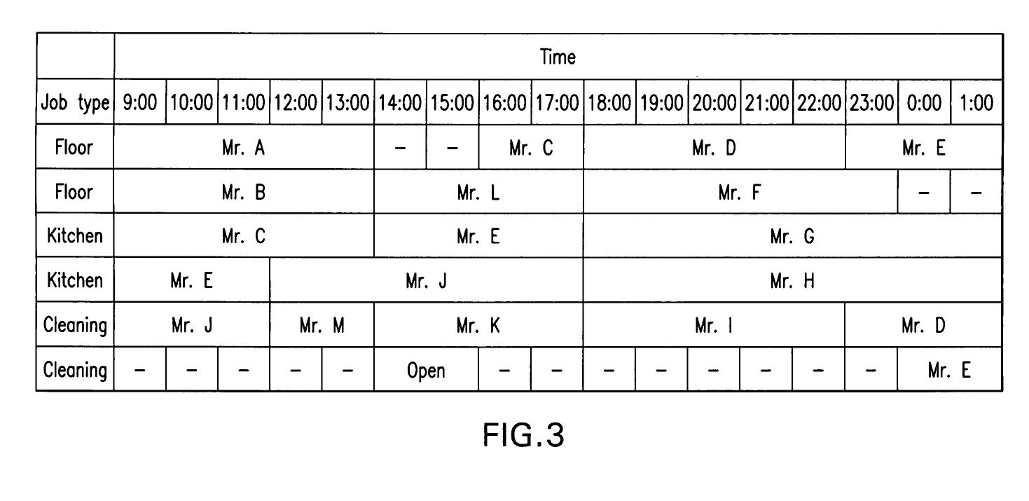

FIG. 2 shows the basic flow for creating a shift based on the above conditions. FIG. 3 shows an example of a shift table for which automatic assignment of staff has been completed. Staff is assigned in order of the highest work evaluations in accordance with the number of applicants from the number of reserved persons in the time blocks (cells) provided for each duty in the shift table.

In FIG. 2, first, cells for time blocks for each type of duty such as floor worker, kitchen, etc. are created, and the cell conditions are designated in units of cells. Staff with high evaluations in the respective dues are nominated and input for each duty and a reservation pattern is applied. Priority cells are selected at time of automatic assignment. The cell priority order and staff priority order for automatic assignments are set in units of cells. Automatic assignment of staff is performed based on a pre-posting assignment order. Desired staff are provisionally finalized. After automatic assignment has been performed again, pre-posting shift finalization is made, and at the same time pattern application is carried out and shift entry is commenced.

After a set time has passed, entry is closed, and based on post-posting order, automatic assignment is performed. Desired staff are provisionally finalized. For undecided cells, conditions are relaxed and automatic assignment is performed. Shift finalization is made and if there are empty cells, and an e-mail giving notice of the blank cells is sent to the relevant persons.

The specific configuration of cell and shift creation will be explained in detail. A reservation pattern is agreed to by staff and the company (employer) and is a employment mode in which the store at which one can work, day of the week, time, duty, etc. are registered in advance. Further, for pattern reservations, registered reservation patterns are registered into shift table cells in a reservation format.

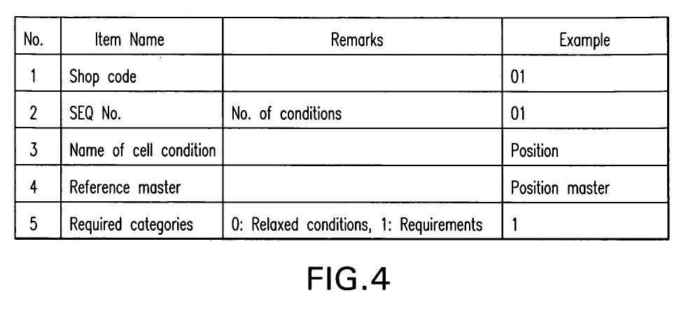

FIG. 4 shows an example of a cell condition master, in which item names, remarks and examples are defined. A work title master is given as an example of a reference master.

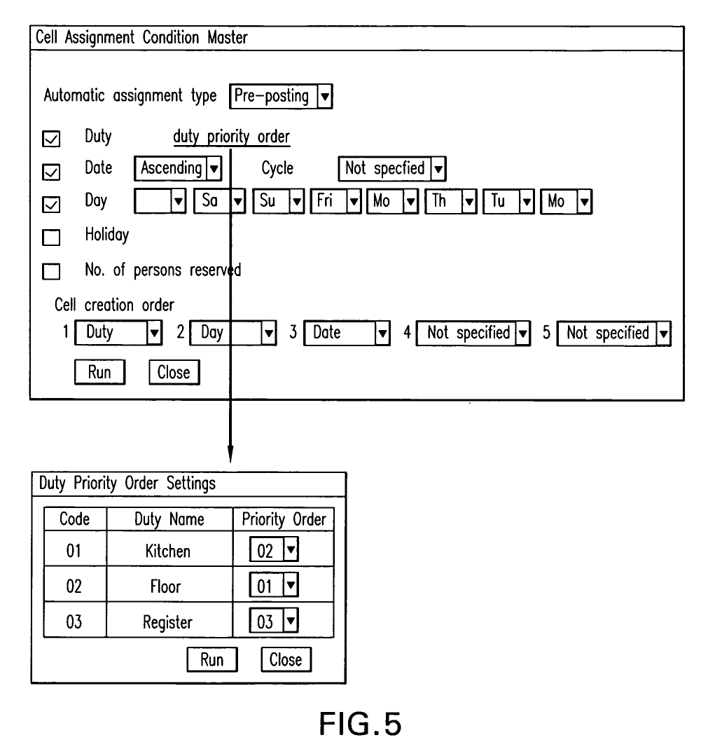

FIG. 5 shows a specific example of the settings screen of a cell assignment condition master. In this example the settings comprise necessary items and selection items, and the necessary items comprise automatic assignment type and cell assignment priority order and the selection items are duty, date, cycle, day of the week, number of persons reserved and cell creation order. The selection items become active by entering a checkmark in the item.

The cell assignment condition master determines cell assignment priority order, and constitutes data relating to the automatic assignment type, duty, date, cycle, day of the week, number of persons reserved, cell creation order, and cell assignment priority order, and is set by entering prescribed data using the setting screen. In this example, cells with fewer reserved persons are given priority with respect to the number of persons recruited. However, cells having one reservation per one recruit are given priority.

For automatic assignment types, selection can be made of “before posting” or “after posting”. For duties, the priority order is set for each duty by inputting duty code, duty name and priority order in the duty priority order setting screen. The example shows the floor ranked first, the kitchen ranked second and the registers ranked third.

Date and time assignment conditions set cell assignment order, and the items that can be set are date order, day of the week priority, time priority, and date cycle order.

For dates, settings are made for ascending, descending, ascending/descending repeating of the dates in the shift table. For days of the week, weekend/holiday priority and weekday priority are set. For time, priority assignment is made starting from cells that include an inputted time, such as 12:00. For the date cycle, the assignment commencement date is the first day of the shift table, and assignment is made in any of the cycles of every three days, every five days, and every 10 days.

The cell assignment priority order is for determining what to assign priority, and as shown in the example in the diagram, first is duty, second is day, third is date and fourth and fifth have not been set.

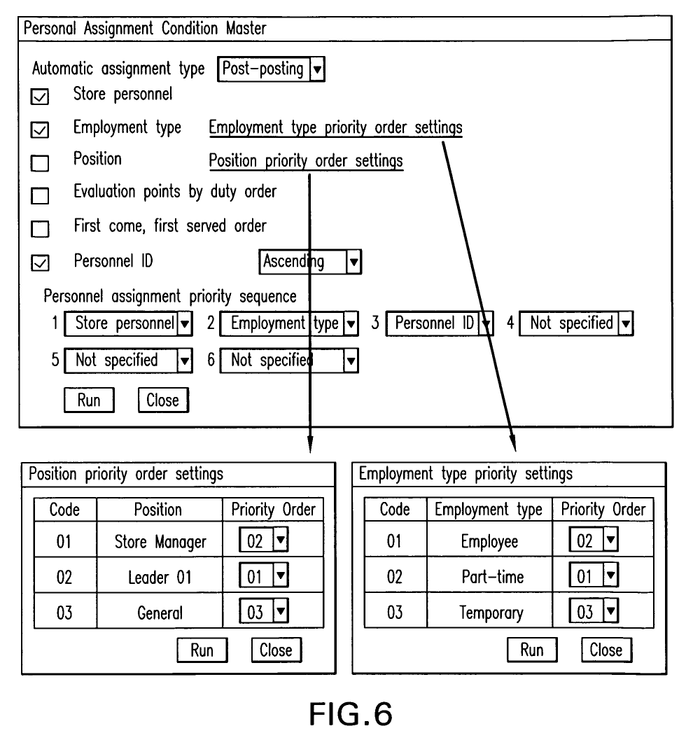

FIG. 6 shows a specific example of a setting screen of a personnel assignment condition master. Personnel assignment conditions and date and time assignment conditions are set, and assignment order is determined with AND conditions. The personnel assignment conditions determine staff assignment priority order.

In this example, settings consist of necessary items and selection items, and for the necessary items, there are automatic assignment types and personnel assignment priority order; also, for the selection items, there are assigned store, employment mode, position, evaluation points by duty order, first come, first serve order, and staff ID. The selection items are made active by checking with a check-mark.

In the setting screen, assignments are made in assigned store staff order, that is, from assigned store staff. For employment mode, employment mode priority settings are opened, and the employment mode name (employee, part-time, temporary) is designated and priority order is set. For job position, the job position priority order setting screen is opened, and the position name (store manager, leader, general, etc.) is designated, and priority order is set. To set the above two priority orders, an employment mode master and position master are prepared and employment mode names and position names are entered in these masters in advance.

Regarding evaluation by duty point order, persons are assigned in the order of the highest evaluation points first. For first come, first served order, reservation pattern staff is necessarily given priority. For staff ID, ascending order or descending order are set. Using the above selection, the personnel assignment priority order is set from 1-6. As shown in the figure, with first priority is the assigned store, second is employment mode, third is staff ID, and fourth onward are not designated.

The flow of the above shift creation will be explained in greater detail by screen transitions.

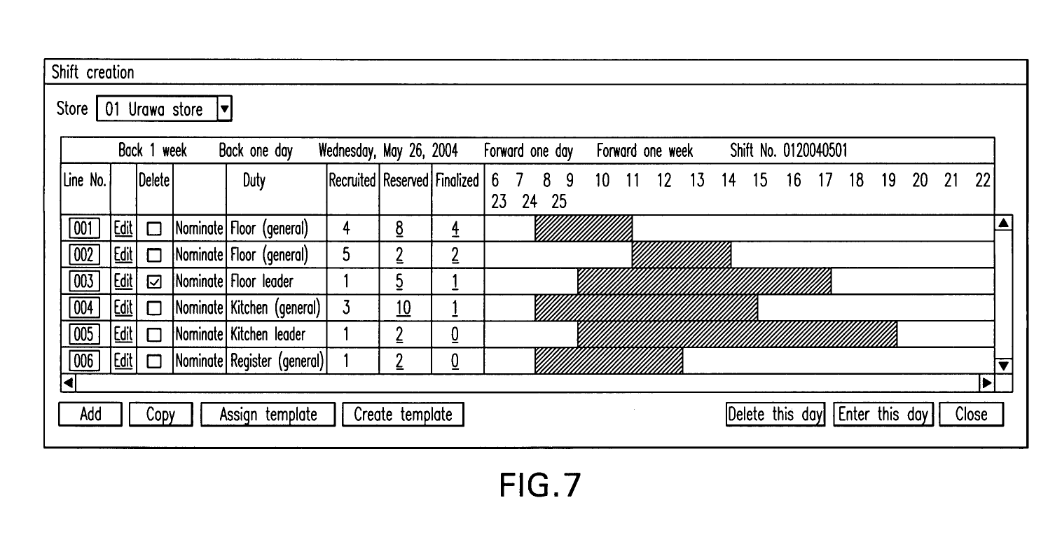

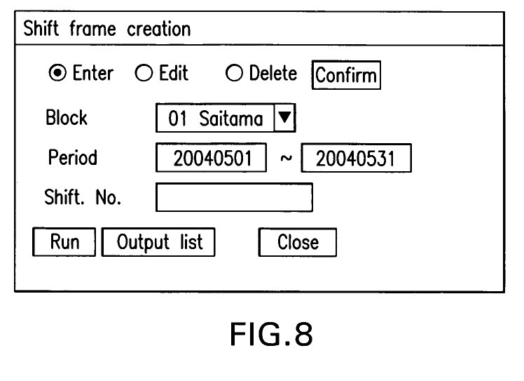

FIG. 7 shows single specific example of a shift creation input screen. FIG. 8 shows a single specific example of a processing sorting screen for creating a shift frame. Shift creation is performed in units of blocks for each time period, and saved as a template. Here, the block unit is are a group of stores.

In FIG. 8, a shift frame is created, and processing categories are finalized by entering, correcting or deleting information and pressing the confirmation button. In the shift frame, the block, time period and shift number are set. Blocks are designated from among stores registered in advance displayed in the sub-window. The time period is entered when creating a shift. For the shift number, the applicable shift number is entered when editing or deleting a created shift table. Cell information, number of applicants, reserved staff or finalized staff are output in a list.

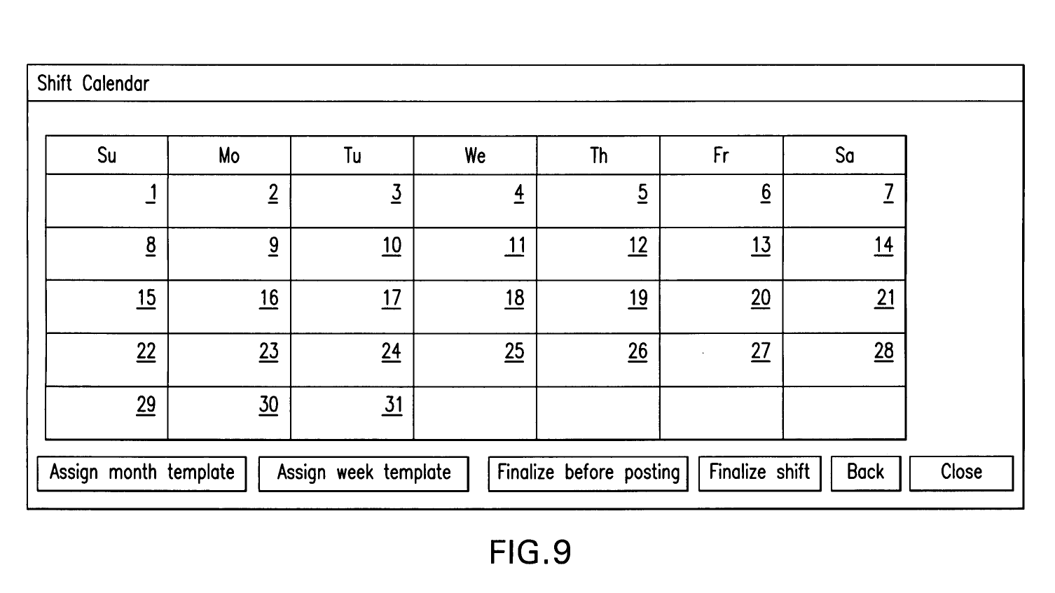

When the Run button of the processing sort screen is pressed, a screen transition is made to the shift calendar shown in FIG. 9. In the shift calendar, a date for creating the cell is selected and shift-unit based copying, template assignment and finalization are performed. From this screen, transitions are made to the screens for shift creation, monthly template assignment and weekly template assignment and processing is performed. Pre-posting finalization is performed in shift table units. Shift finalization is performed in shift table units.

When a date is selected with the shift calendar, the shift creation screen shown in FIG. 7 is displayed. For shift creation, a store for which cells are to be created is selected, and cells are displayed the previous week from the current date, the next week, and the previous day and the next day. For the line No., the line number is entered. The number of lines is automatically input when lines are added. When the order of listing is changed, the line number is changed, and a shift table is created after the “Register this day” button is pressed.

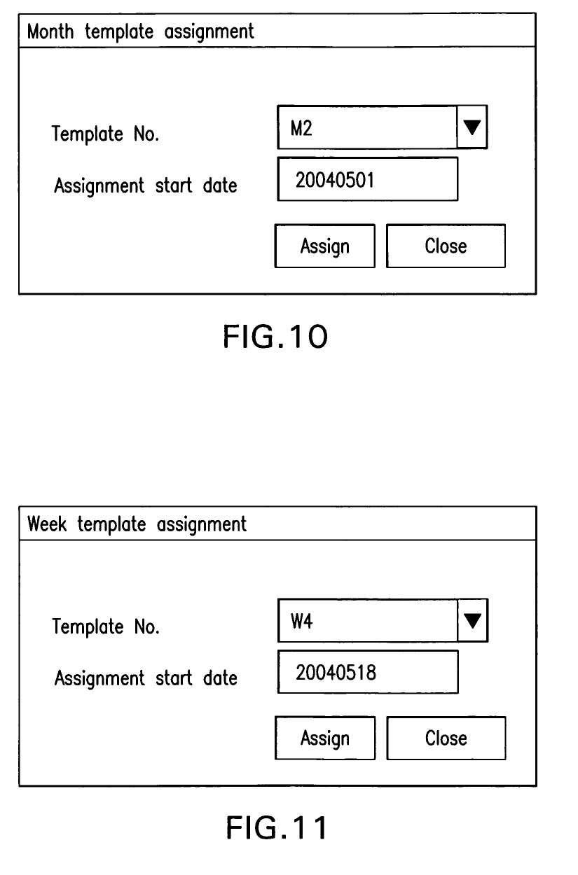

Operations when creating a shift table will be explained in greater detail while referring to the various screens. FIG. 10 shows a specific example of a monthly template assignment screen and FIG. 11 shows a specific example of a weekly template assignment screen.

The date designated in the shift calendar is made the start date and a monthly template and weekly template are assigned to the shift table. The monthly template is assigned in the following manner: a number for an assigned template is designated, an assignment start date is inputted, the assign button is pressed, and a monthly template with an item number affixed is assigned. Similarly, the weekly template assignment is assigned in the following manner: a number for an assigned template is designated, the assigned start date is inputted, the assign button is pressed, and a weekly template with item number affixed is assigned.

Editing, deleting or nomination in a shift table is carried out by clicking on the respective function buttons to display the respective dedicated screen, and then entering the prescribed data. To add lines, the add button is pressed to open a dedicated screen to input the prescribed data. Operation of the dedicated screens is described below.

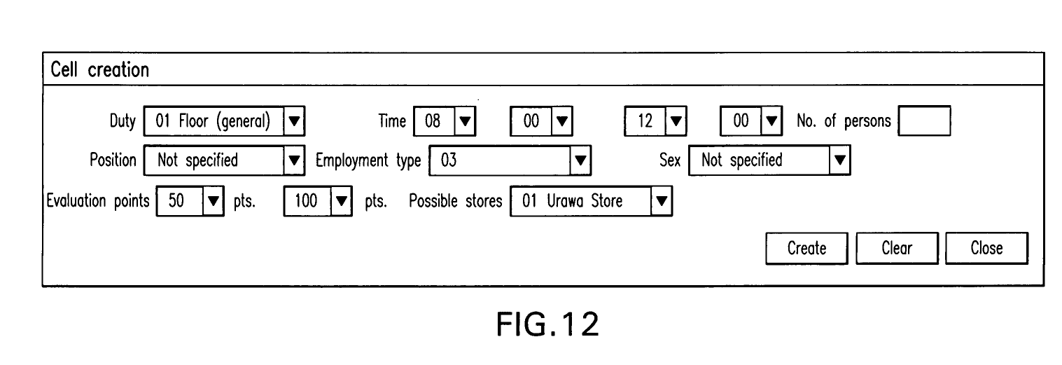

Clicking “Edit” on the selection line displays the cell creation screen of FIG. 12; a cell is created by designating cell conditions. Duty, time block, number of persons, order, employment mode, sex, evaluation points, and possible stores are designated, and when the Create button is pressed, a cell is created on the shift creation screen shown in FIG. 7. The Clear button clears the designated cell conditions.

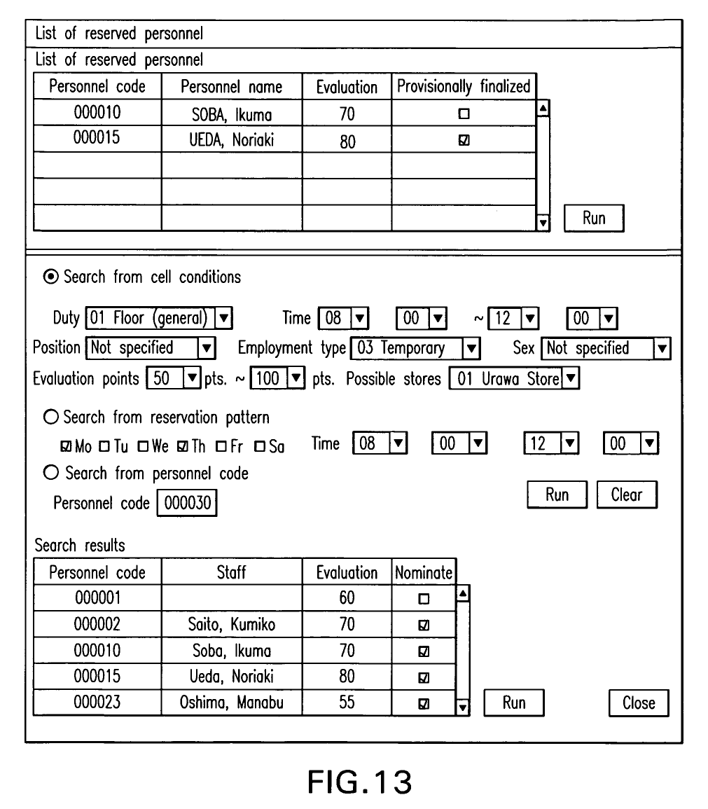

When a check is entered in the “Delete” of the selection line and the “Register this day” button is pressed, the selected cell is entirely deleted. When “Nominate” of the selection line is clicked, the reservation staff search screen shown in FIG. 13 is displayed, enabling nomination input in the selected cell. The staff reserved in advance is listed on this screen, and the staff for which zero points for preliminary finalization were entered will not be dropped from selection in automatic assignment. When the “Run” button is pressed, all of the reserved staff of the cells and the preliminary finalization are all registered at once.

When searching based on cell conditions, cell conditions set with the cell creation screen may be carried over to the next screen. When searching based on reservation patterns, a reservation pattern is designated and searched for. When searching based on staff codes, a staff code is designated and searched for.

The above three search methods are designated, and once the “Search” button is pressed, a search is carried out in accordance with the search conditions. The search results are displayed in a list and from among these, nomination of the specified number of persons is made in the order of highest evaluation points, by putting a check in the nomination column and pressing the “Nominate” button. With this operation, all of the entries are registered in the reservation list.

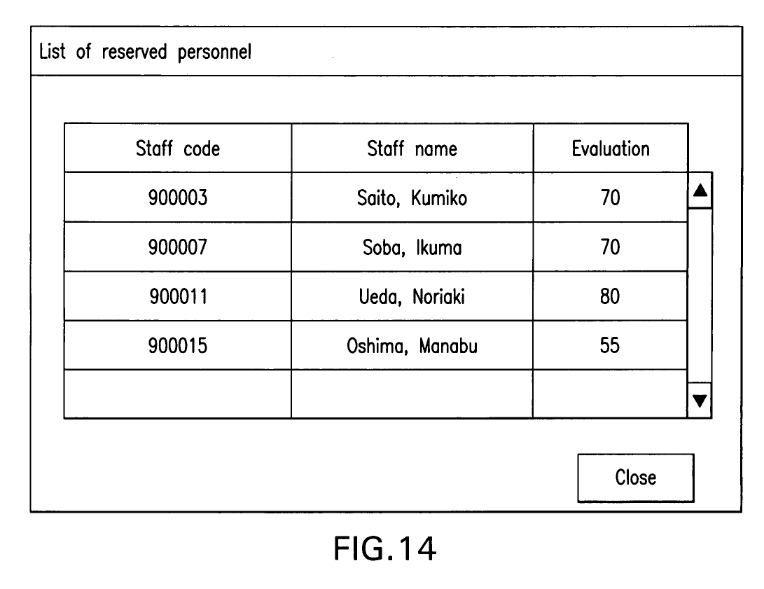

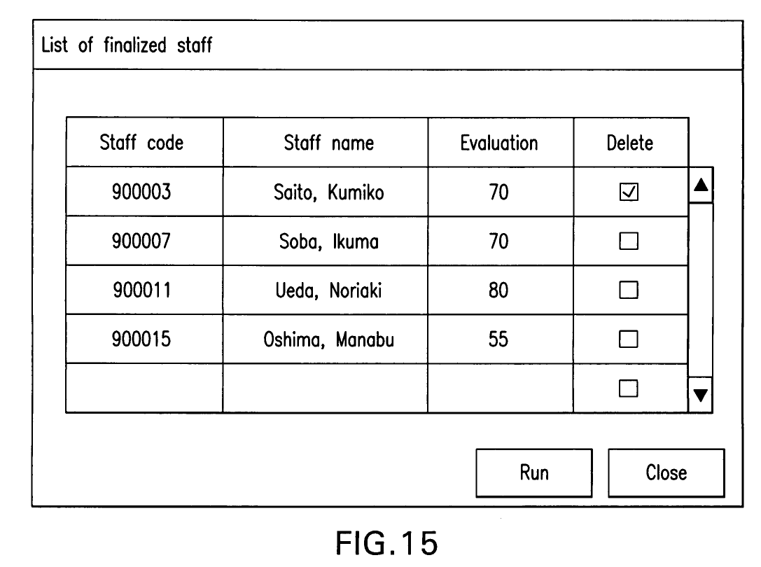

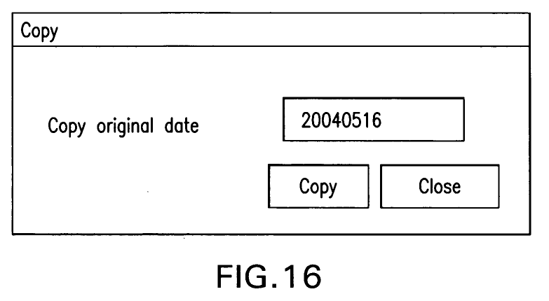

If the reserved “number” of the selected lines is clicked, the reserved staff list screen shown in FIG. 14 is displayed, and the reserved staff names and evaluation points are listed. If the confirmed “number” of the selected lines is clicked, the confirmed staff list screen shown in FIG. 15 will be displayed and the confirmed staff names and evaluation points will be displayed in a list. When deleting confirmations, a checkmark is entered to delete, and all of the entries are deleted when the “Run” button is pressed.

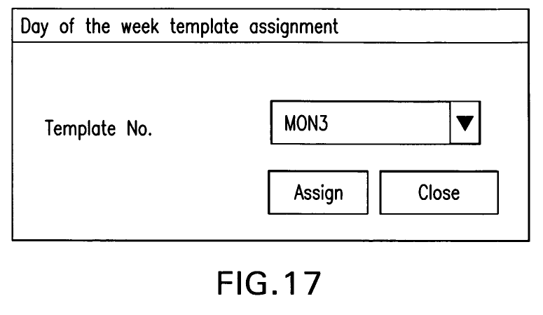

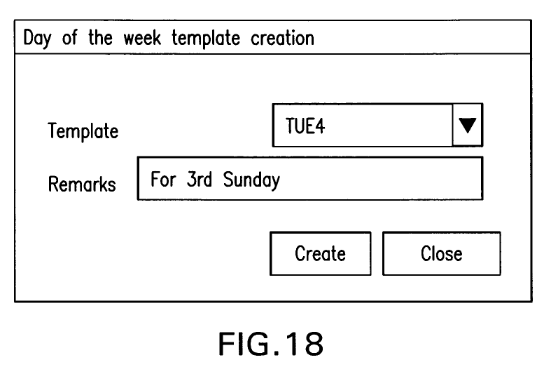

When the “Assign template” button is pressed, the day-of-the-week template assignment screen shown in FIG. 17 is displayed, the template No. is selected and inputted, and the template No. entered by pressing the “Assign” button is assigned. Pressing the “Create template button” displays the day-of-the-week template assignment screen shown in FIG. 18, and a template No. is selected and inputted and by pressing the “assign” button, the entered template No. is assigned. Pressing “Delete this day” deletes all cells for the current date. Pressing “Register this day” results in all cells for the current date being stored.

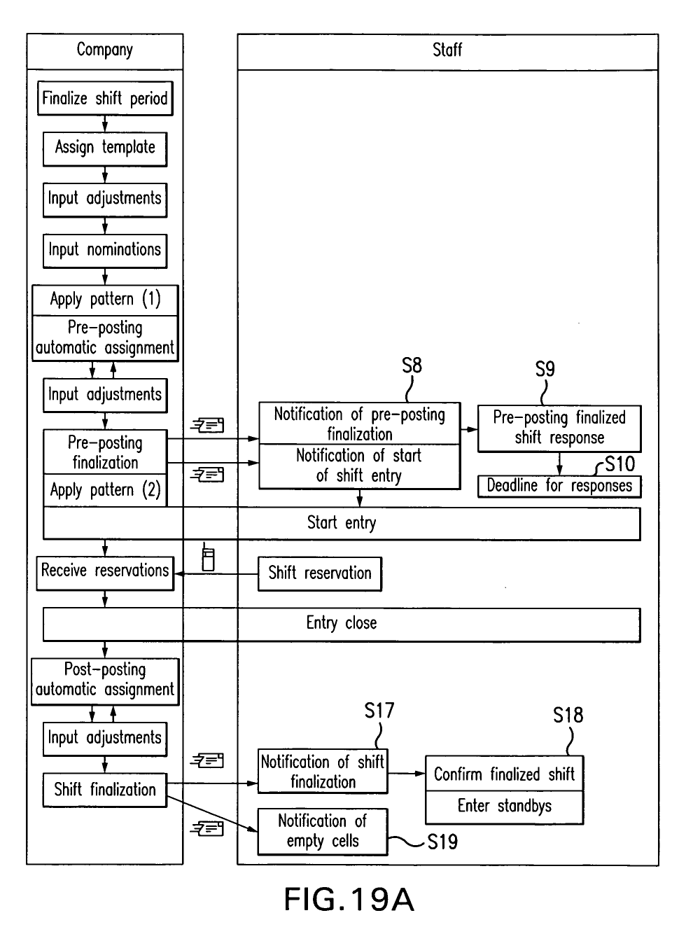

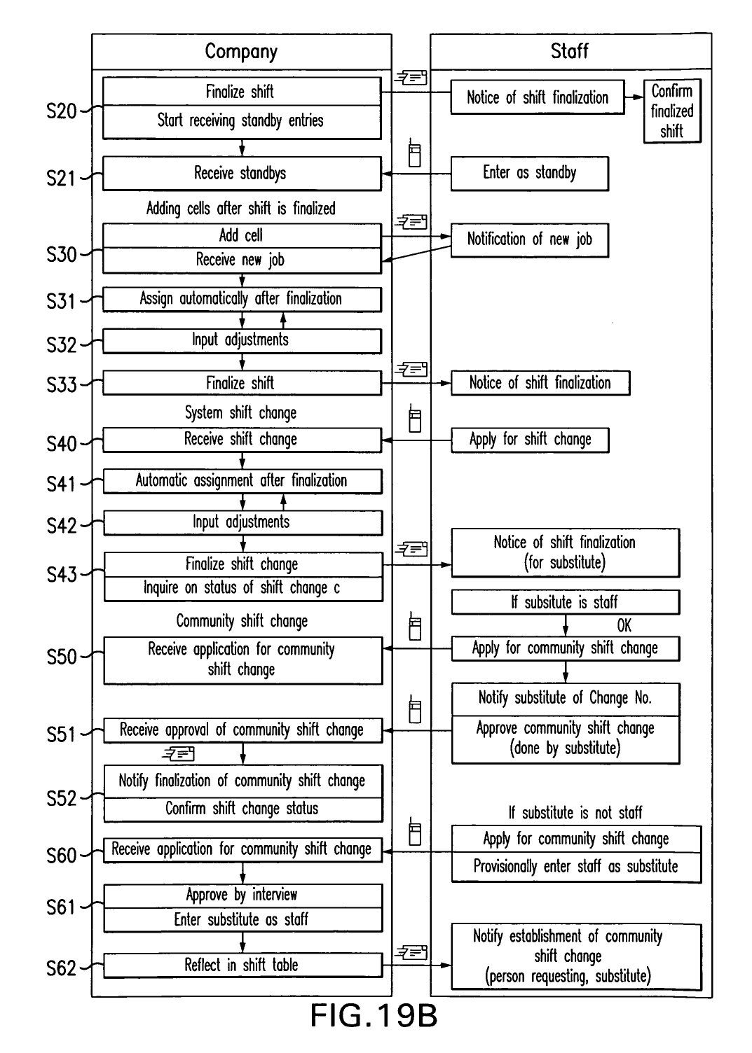

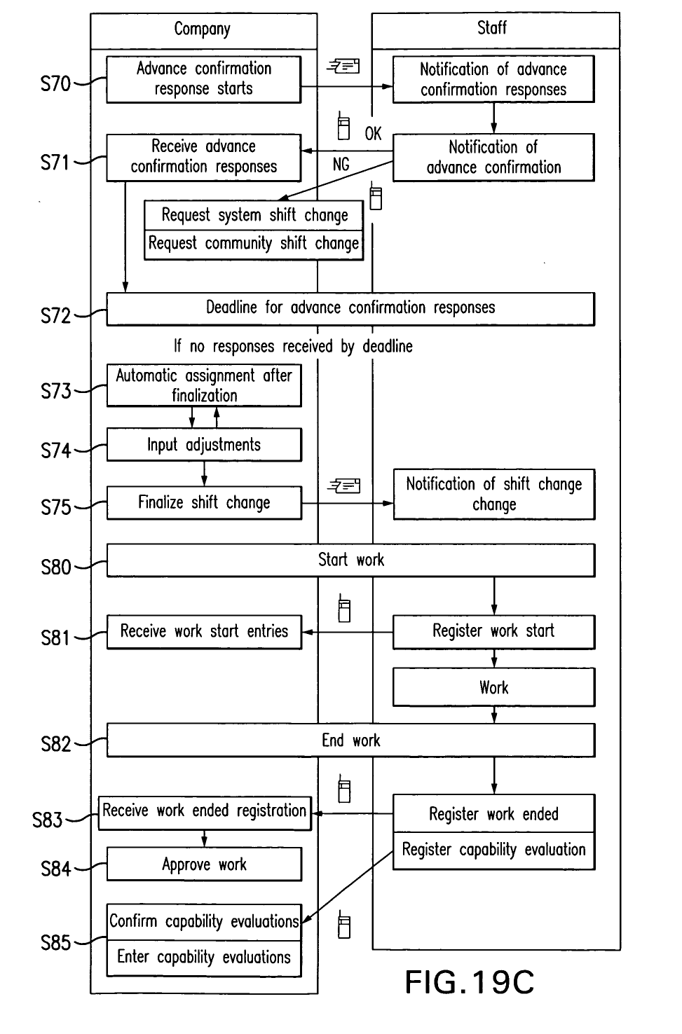

FIGS. 19A-19C show the flow of the system overall in the present embodiment.

First, before posting, the shift period is designated and along with creating a shift frame, cell conditions are set in cell condition master (Step S1). Next, month, week or day-of-the-week templates are assigned (Step S12). Adjustments are made such as adding cells not in the template, deleting cells that are not necessary and changing cell conditions (Step S3). The nominated staff is designated (Step S4). The designated staff becomes the finalized staff.

A pattern reservation (apply pattern (1)) is made in cells where the entered day, time block and duty match. Here only the cells of the assigned store are reserved. Appropriate shift assignments are made (pre-posting automatic assignment) (step S5). Staff adjustments are performed based on results of the pre-posting automatic assignment. The desired staff in these arrangements is finalized. The finalized staff is not shuffled (dropped down the list) even if automatic assignment is carried out again before posting. (Step S6)

Finalization before posting (provisional finalization) (Step S7) is performed when pre-posting staff is decided (Step S8). Finalized staff send shift responses by the deadline as to whether they can work (Step S9). Shift responses are accepted up to the deadline date (Step S10). In Step 7, when the staff has been determined by pre-posting finalization, a shift entry start e-mail is sent to staff of a possible store determined to be staff by pre-posting finalization (Step S8). With pattern application (2), reservation is performed in cells of possible stores matching staff not assigned in pattern application (1). Then the shift table is posted and reservation entry from mobile phones is commenced (Step 11).

Once the reservation entry has started, shift reservation for the relevant work is received from the staff (Step S12). Once a predetermined time has passed, reservation entry from mobile phones is stopped (Step S13). After posting, automatic assignment is performed, and the reservation staff is assigned to cells in order according to the evaluation points (Step S14). In the same way as step 6, staff adjustment is carried out based on results of automatic assignment after posting (Step S15), and shifts are finalized (Step S16).

Shift finalization e-mails are sent to staff decided and staff undecided through shift finalization—that is, to all staff that applied when the reservations were accepted (Step S17). For the finalized staff, the finalized shifts are confirmed, and the staff excluded from the finalized shifts are registered as standbys (Step S18). In shift finalization, when there is an empty cell, staff satisfying the cell conditions are notified of same via e-mail (Step S19).

If a cancellation is made due to staff not being able to do the automatically assigned work for staff by the shift finalization (open cell) or for some reason of the finalized staff, receiving of standby registration is commenced (Step S20). With standby registration, for shift tables for which work is already confirmed, receipt of standby is received in date and time units. (Staff S21).

Next, adding cells after a shift has been finalized, system shift changes and community shift changes will be explained.

(Addition of New Jobs after a Shift has been Confirmed)

If a new job comes up, a cell corresponding the new job is added, staff are notified of the new job, and reception starts (Step S30). In the advance confirmation of Steps S8-S10, with respect to all open cells having no response, automatic assignment is performed (step S31). Staff adjustment is made based on results of automatic assignment (Step S32). After Steps S31 and S32 are repeated, the shift change is confirmed and the confirmed staff are notified via e-mail (Step S33).

### (System Shift Change Function)

The system shift change function processes requests to arrange for replacements or substitutes if staff cannot work or for other necessity. A community shift change is prioritized, and if that isn't possible, arrangements are made for substitutes with a system shift change. If a shift is not pre-confirmed by the deadline for staff advance confirmation, the system deems staff to be insufficient, and a system shift change is automatically carried out.

When a system shift change is started, first, staff currently registered are excluded, and the set evaluation points given to the staff. Substitute personnel meeting the conditions are extracted from the standbys, and listed in evaluation order, persons are assigned from the top down, a response specifying time is added and confirmation is made via e-mail to the substitute candidate that they have been entered in the schedule. If no confirmation response has been received by the designated time, an evaluation point is added, the person is removed from the duty and the process is begun again.

If there is no staff in standby, from among the entire registered staff, those meeting conditions other than work days are extracted, an e-mail explaining the open duties is sent and staff apply for the same via a website; if there is a plurality of applicants, the system lists them in order of their evaluation points and assigns them from the top-ranked down.

If staff meeting the conditions cannot be assigned, the system searches again for standbys with relaxed set conditions. For assignment, selection can made adding such conditions as operating day priority, duty priority, priority of individual duties, as well as assignment such that imbalances do not occur. Further, even with assignments for individual duties, assignments are made based on various conditions such as possible work days, work time, possible duties, rank, qualification, sex, age, of staff. With assignment of more than the number of persons required, the applicants are arranged in evaluation order, and factors such as consecutive days worked and consecutive hours worked as stipulated by labor laws are considered. Further, setting can be made so that limits by individual settings for annual income or number of hours worked of staff are not exceeded.

Regarding the shift system changes, if a staff member does not make advance confirmation, arrangements are made with other staff members and such staff member is not registered for the duty. As a result, staff will always make advance confirmation; this system is also useful in helping staff develop a sense of responsibility with respect to work. Further, for the company, this leads to preventing sudden absences of staff and makes it possible to avoid the risk of being short of staff for any given day.

Specifically, when a system shift change arises, an e-mail is sent to staff meeting the conditions, and substitutes are assigned for times that the company has set from the staff group that responded.

Following shift finalization, if a staff member cannot arrange substitutes, a system shift change is applied for and the company accepts a shift change (Step S40), and automatic assignment is performed (Step S41). Staff adjustments are made based on the results on the automatic assignment after finalization (Step S42). After these steps S41 and S42 are repeated, a shift change is finalized, and the finalized staff is notified via e-mail. Meanwhile, the company may query the status of the finalized shift change. (Step S43).

### (Community Shift Change Function)

If a staff member cannot work, in order to fulfill his or her work responsibilities, such staff member introduces someone at the same workplace or an unregistered friend to the company, and if accepted that person is assigned as one's own replacement (substitute). The substitute will have the same responsibility with respect to the work as the original staff member did, from the time such assignment is made. With this method, because replacements are searched for from one's own personal relationships, this places importance on communication with other staff on a day-to-day basis; it is useful in building character so that trust relationships can be formed. For the above reasons, with this system, preference is given to use of community shift changes.

If a substitute is a staff member, community shift change is performed using the following processing.

The staff member asks another staff member is requested to be a substitute, and makes request to the system for a community shift change, requesting that the substitute be accepted. Once this is received, the substitute is notified of the change no. (Step S50).

When the substitute has confirmed that he or she will accept the work, the change no. is input and the community shift change is accepted (Step S51). Once the substitute has accepted the job, the company is notified of the community shift change. In this way, the company can grasp the status of the community shift change (Step S52).

If the substitute is not a staff member, a community shift change is made with the following processing.

At the same time as the application of a community shift change is made to this system with a mobile phone e-mail, a substitute is provisionally registered (Step S60). Once this is accepted, the company interviews the substitute, and if hired as staff the person is officially registered as staff. (Step S61). The company changes the shift “requester” to “substitute” and this is reflected in the shift table. Later, an e-mail regarding establishment of community shift change is sent to the requester and to the substitute (Staff S62).

Advance confirmation will be explained. With this system, the intent to come to work is confirmed before the staff member is scheduled to work. The object of advance confirmation is raising staff awareness with respect to work, discovering absences early, and arranging for substitutes.

Once finalization of a shift is completed with Step S20, the staff is sent a shift finalization notification by e-mail (Step S20). At the same time, advance confirmation response is commenced (Step S70). A staff member makes an advance confirmation response and the number of responses is determined by a setting. When a staff member has accepted with the advance confirmation, acceptance of advance confirmation responses is performed (Step S71). On the other hand, if a staff member does not accept with advance confirmation (NG), a system shift application and community shift change application are performed, and advance confirmation responses are no longer accepted (Step S72).

If staff does not respond during the advance confirmation response period, automatic assignment is performed (Step S73). After finalization, staff adjustment is performed based on automatic assignment results (Step S74). The shift change is finalized, and the finalized staff is notified of the results via e-mail. (Step S75).

When work is started (Step S80), each staff member is registered as having started work (Step S81). Work is started and then when work is completed (Step S82), each staff member makes work completion registration (Step S83), and confirmation of such work is accepted (Step S84). When work is completed, each staff member inputs a self-evaluation, staff evaluation, and store manager evaluation, and then the store manager inputs the evaluation for each staff. The company, based on the staff and store manager assessments and referring to predetermined evaluation standards, calculates capability evaluation points, and stores the same in a database (Step S85).

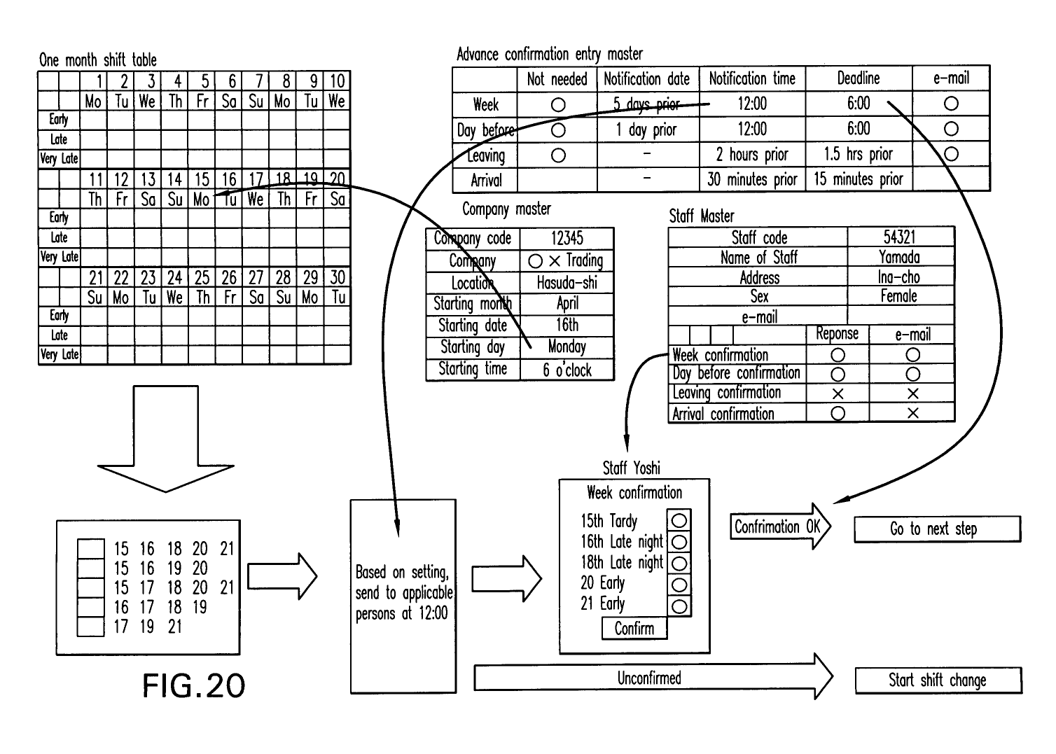

FIG. 20 is a diagram explaining advance confirmation. The system of the embodiment is provided with function executing means (a program) to perform advance confirmation, and has means for setting whether the pre-conformation is to be performed or not. Once advance confirmation is started, the advance confirmation registration master, company master, and staff master are referred to and advance confirmation corresponding to for each staff member is performed.

There are four types of advance confirmation: week confirmation, prior day confirmation, leaving confirmation and arrival confirmation. Each advance confirmation operates in accordance with conditions set in the advance confirmation registration master. Specifically, the items are whether the advance confirmation is needed or not, notification date, notification time, response deadline, and e-mail. In the example in the diagram, notification of the week, day before and leaving are “required” and arrival is “not required”; for week, notification is made five days in advance; for the day before, one day in advance, and the notification times are 12:00 for week and prior day, 2:00 for departing, 30 minutes prior for arriving; the deadline is 6:00 for week and the day before, one and a half hours prior for departing, and 15 minutes prior for arrival; response is possible by e-mail for the day before and departing, but not possible for arrival. Set in the staff master table is whether there has been advance confirmation for each staff member and whether same is carried out by e-mail. Here, the response is made with “O”. “X” means a response is not made. For e-mail, “O” means an explanatory e-mail will be sent. “X” means an explanatory e-mail will not be sent.

For week confirmation, one week is set based on the first day of the week of a period set by the company master, and applicable persons for the week for which week confirmation is to be performed are extracted from a shift table (See FIG. 20). From the extracted staff, persons for whom response by staff master is necessary are extracted. Staff can make confirmation at the notification date and time set by the advance confirmation master using their mobile phone, etc. From among the staff from whom a week confirmation response is needed, those persons set by staff master as email recipients are extracted, and an advance confirmation notification e-mail is sent to such staff members. For the staff, week confirmation is performed until the response deadline time set by the advance confirmation registration master. If no confirmation is made, the system determines this to be an absence and arrangement of a substitute (shift change) is commenced.

Confirmation the day before is carried out as follows. The applicable persons are extracted from the shift table, and from among the applicable persons, the applicable persons for whom a setting by staff master has been made indicating that response is necessary are extracted. Confirmation can be made by a user communication terminal at the notification time set by the advance confirmation registration master. From among the applicable persons requiring prior day confirmation response persons for whom the setting by staff master is sending by e-mail are extracted, and advance confirmation notification e-mails are sent to the applicable persons. The applicable persons who receive an e-mail confirm the response deadline time set by the advance confirmation registration master and perform prior day confirmation by then. The system determines whether the applicable person has responded to the advance confirmation e-mail, and if there is no response (unconfirmed), substitute arrangements are started.

Confirmation of leaving for work is carried out as follows. The applicable persons are extracted from the shift table, and from among the applicable persons, those for whom staff master indicates that a response is necessary are extracted. Confirmation can be made by a user communication terminal at the notification time set by the advance confirmation registration master. From among the applicable persons from whom a prior day confirmation response is needed, those persons for whom the setting by staff master is sending by e-mail are extracted, and advance confirmation notification e-mails are sent to the applicable persons. The applicable persons receive an e-mail, confirm the response deadline time set by the advance confirmation registration master, and make prior day confirmation by then. The system determines whether the applicable person has responded to the advance confirmation e-mail, and if there is no response (unconfirmed), substitute arrangements are started.

Confirmation of arrival is carried out as follows. The applicable persons are extracted from the shift table, and from among the applicable persons, those persons for whom staff master indicates that response is necessary are extracted. Confirmation can be made by a user communication terminal at the notification time set by the advance confirmation registration master. From among the applicable persons from whom a prior day confirmation response is needed, applicable persons for whom the setting by staff master is sending by e-mail are extracted, and an advance confirmation notification mail sent to the applicable persons. The applicable persons receive an e-mail, confirm the response deadline time set by the advance confirmation registration master, and make prior day confirmation by then. The system determines whether the applicable person has responded to the advance confirmation e-mail, and if there is no response (unconfirmed), substitute arrangements are started.

FIG. 20 shows a reference diagram of a one month shift table, for example, the week confirmation of the 10th (Wednesday) is from the 15th to the 21st, and the applicable persons have been extracted by staff. The confirmation day of each staff is extracted, and for this day, because the week notification time of the advance confirmation registration master is set to 12:00, notification is sent to the applicable person at 12:00 on the 10th. Each staff confirms the advance confirmation e-mail and sends a confirmation response by the response deadline. With this response, the week confirmation for each staff is completed and the process moves to the next step (previous day confirmation→departure confirmation→arrival confirmation). If there is no confirmation response (unconfirmed), arrangements for a substitute (shift change) are commenced, and a substitute is assigned.

Next, the processing for personnel assignment and shift changes in the present system will be explained in greater detail.

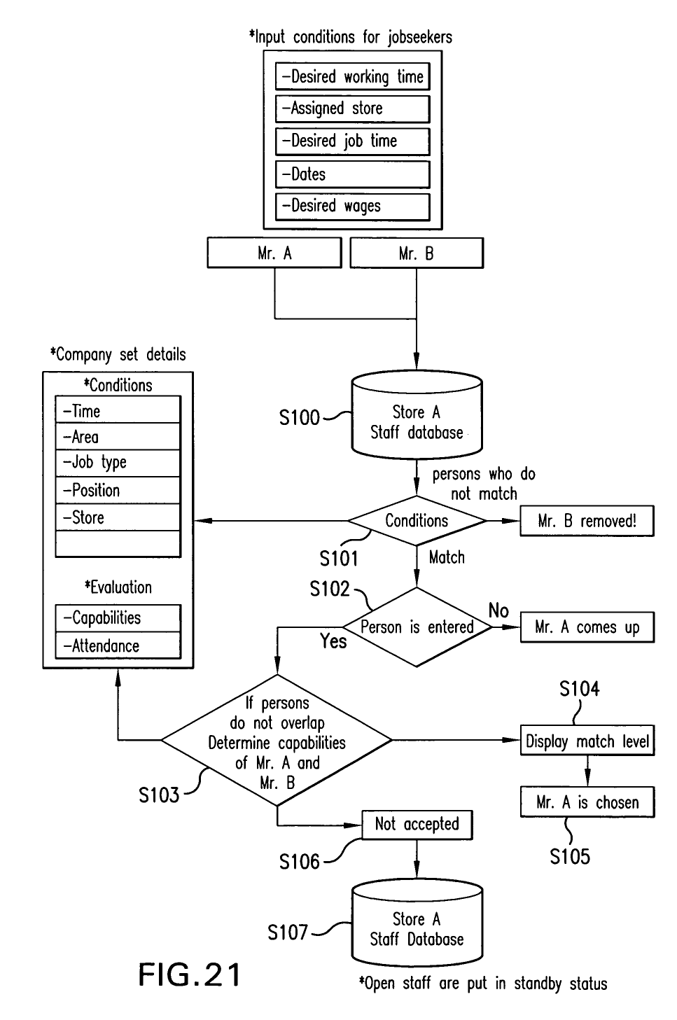

FIG. 21 is a flowchart for assigning a plurality of staff members matching job seeker input conditions.

This automatic assignment is the processing of steps 14-16. This example explains the staff assignment of two persons, but three or more may also be assigned. The staff in this example are Mr. A and Mr. B.

The company sets employment conditions (time, area, salary, job type, position, store), and sets evaluation conditions (capability, attendance and absence) in advance. Mr. A and Mr. B are registered in a staff database for Store A (Step S100). Mr. A and Mr. B are compared against the employment conditions to determine whether they match the conditions (Step S101). A person who does not match, for example, Mr. B, is not applicable. It is then determined whether the next person overlaps (Step S102). If Mr. B is out of consideration based on the determination of Step S101, Mr. A is selected. If both Mr. A and Mr. B match the conditions in step S101, the capabilities of both persons are judged (Step S103). The capabilities of Mr. A and Mr. B are compared based on set conditions; and if, for example, Mr. A is higher, the match level is displayed (Step S104), and Mr. A is decided upon (Step S105). With the decision on Mr. A, Mr. B is determined to be out of the running (Step S106), is saved in the staff database of Store A, and put into standby status as open staff (Step S107).

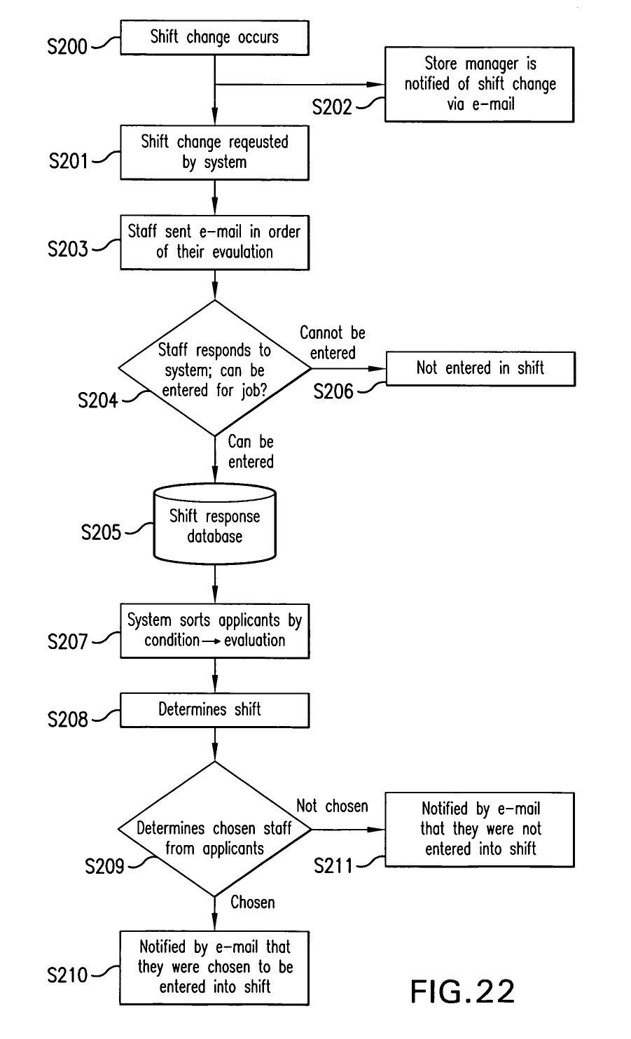

FIG. 22 is a flowchart for creating a shift change. When a shift change is generated (Step S200), a shift change is requested by the system (Step S201), and the store manager is notified by e-mail. E-mail is sent to staff in the order of highest ranked first (Step S203). The staff respond to the system as to whether they will be registered for the job (by response means such as responding by entering their response into the system via a URL link of an explanatory e-mail, or responding by e-mail whereupon the e-mail is automatically read, or via phone, whereupon the response is recognized using voice recognition). (Step S204). Persons entered into the shift are recorded into the shift recruit database (Step S205), while persons that cannot be entered into the shift are removed (Step S206). Applicants that the system has registered into a database are sorted based on employment conditions and capability conditions (Step S207), and the shift is decided (Step S208). Persons chosen to work the shift are determined from among the applicants (Step S209), staff entered into the shift are notified to such effect via e-mail (Step S210). Staff not entered into the shift are notified of such via e-mail. (Step S211).

Various settings for assigning personnel will be explained. Settings for various assignment processing can be made in the cell assignment condition master shown in FIG. 5. When assignment processing is performed, from what day assignment is made can be set by the date. For example, the system can be set to assign from the 25th or from the 1st. Further, assignment can be for all weekends first, then week days, or assignments can be made alternating between the beginning of the month and the end of the month.

For assignment among stores, if there are a plurality of stores with assignments for the same day, settings can be made indicating with which store in a block to commence assignment. If there is staff registered among a plurality of stores, this can ultimately eliminate imbalance by spreading such imbalance for each shift table imbalance.

As for assignment by duty, in cases of assignment of the same store for the same day, if there are a plurality of duties, settings can be made for assignment of the duties on a priority basis. Duties are assigned starting with priority duties, and once assignment is complete, the process can move to assigning the next duty. Further, designated a work cell as priority can ensure a minimum staff for such duties, even when there is a lack of personnel.

Regarding weight placed on specialty and weight placed on assignment, by using settings for staff main duty and sub-duty, selection can be made of assignment processing such that, with main duty, first assignment is made and then preliminary finalization, and then with sub-duty emphasis is placed on specialty. Assignment processing can be set even if there is a small number of available personnel.

### Embodiment 1

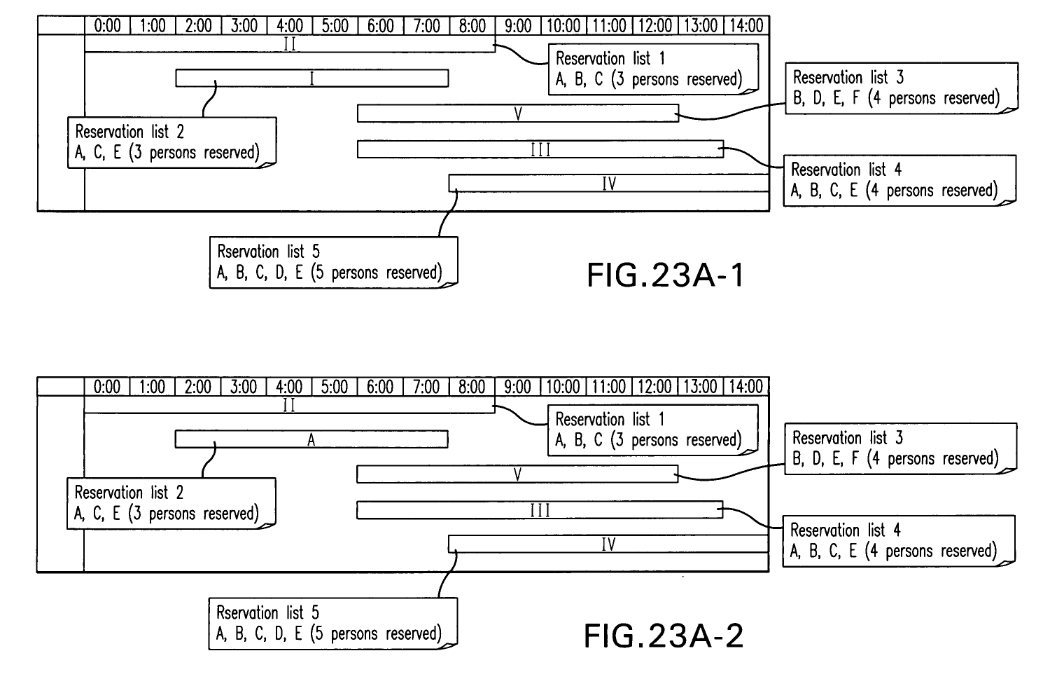

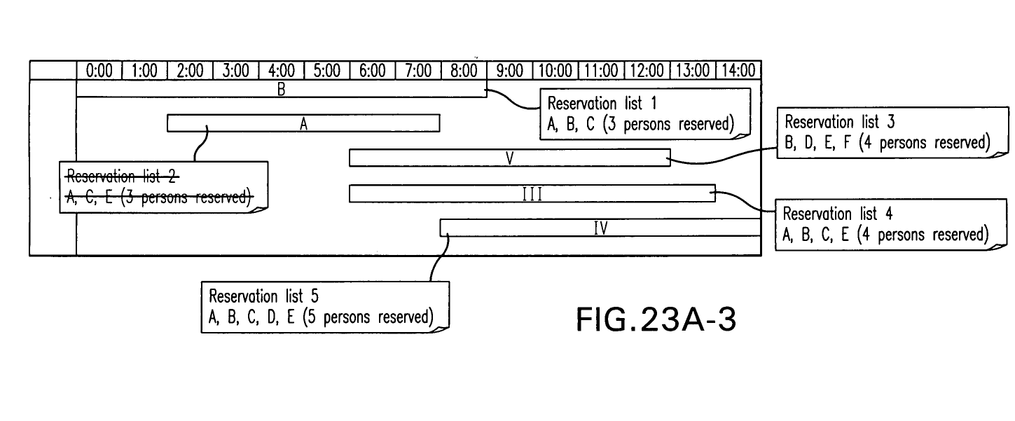

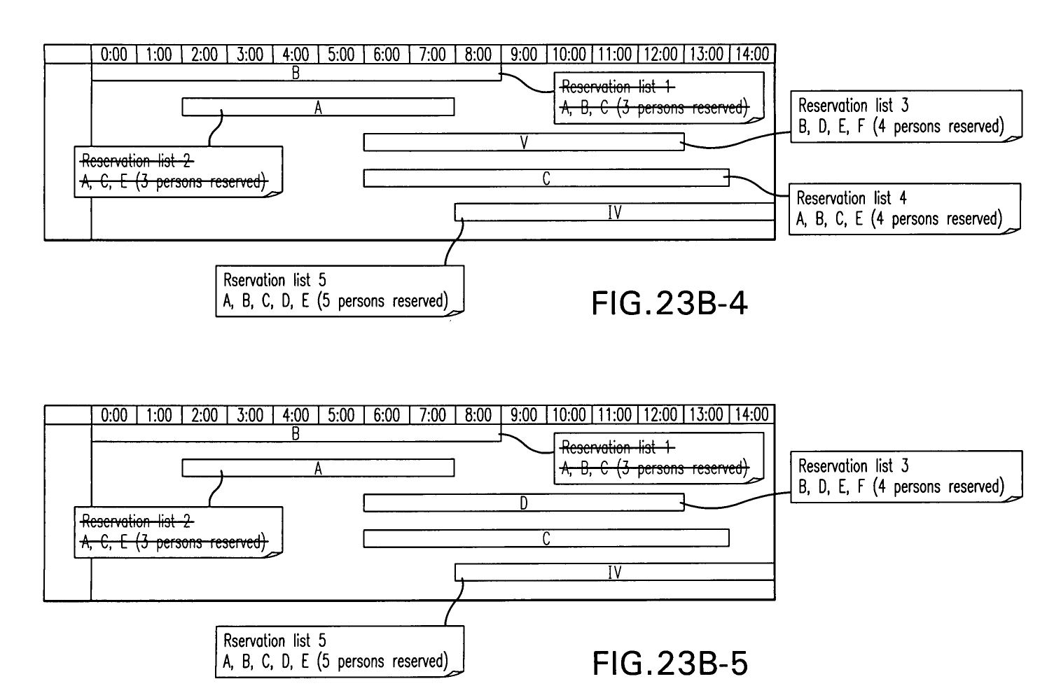

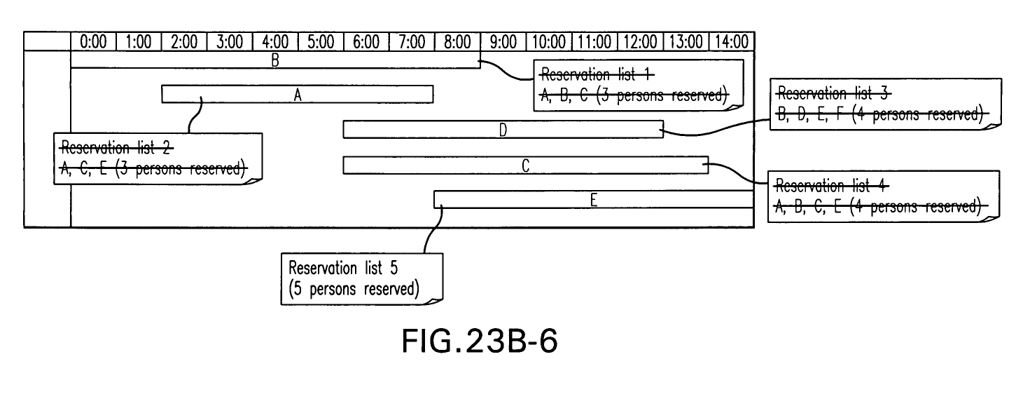

FIGS. 23A and 23B are methods for assigning starting from cells having a small number of reservations. Note that with cells having the same number of reservations, assignments will be starting with cells with earlier priority (in the alphabetic order of the letters and numbers assigned to the cells). Namely, assignment is performed in the order of the circled numbers, (2)→(1)→(4)→(3)→(5).

FIG. 23A (1) shows the state after a reservation deadline, and in the cells the number of persons reserved and the reserved staff can be viewed as a list. Automatic assignment is performed in accordance with the above rules. First in the cell I reservation list, there are reservations for three people, staff members A, B and C, and in the assignment flow of FIG. 21 persons with the highest evaluation are assigned. In this example, staff A is assigned. (FIG. 23A (2)). At the same time, staff B is assigned to cell II (FIG. 23A (3)), staff C to cell III (FIG. 23B (1)), staff D to cell IV (FIG. 23B (2)), and staff E to cell V (FIG. 23 B (3)).

### Embodiment 2

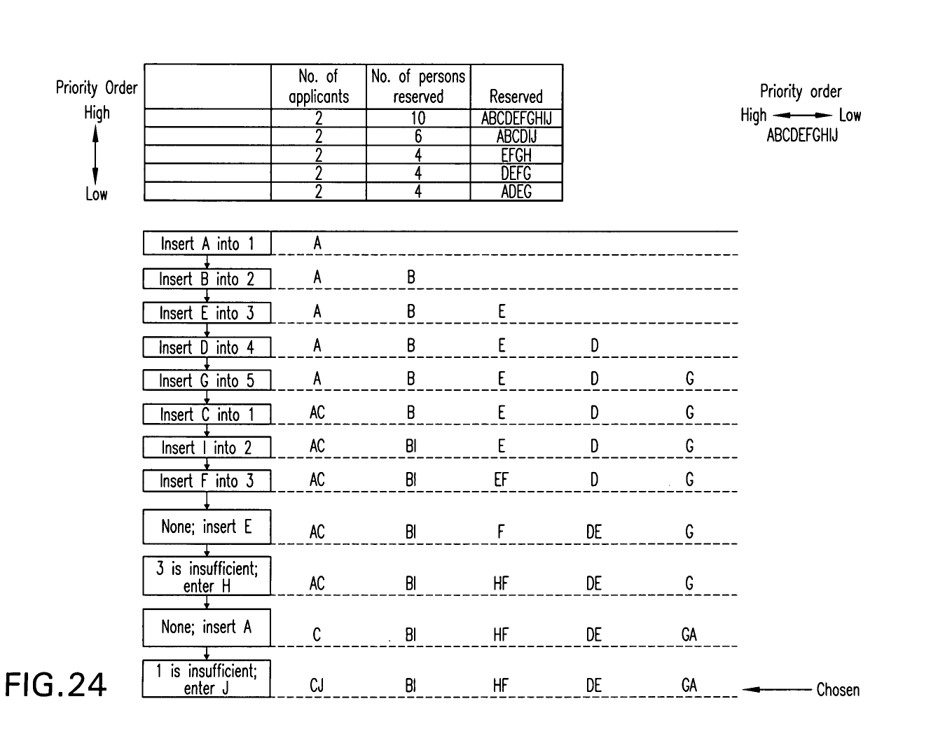

FIG. 24 shows automatic assignment such that assignment of reserved persons to cells based on priority order among cells and on staff priority order has been prioritized (rule application where empty cells are not made). The figure shows one simulation where with respect to the persons applying for each cell, the same number of persons are assigned, the priority order among cells and staff priority order are lined up, assignments of reserved persons to cells are made in order and decided.

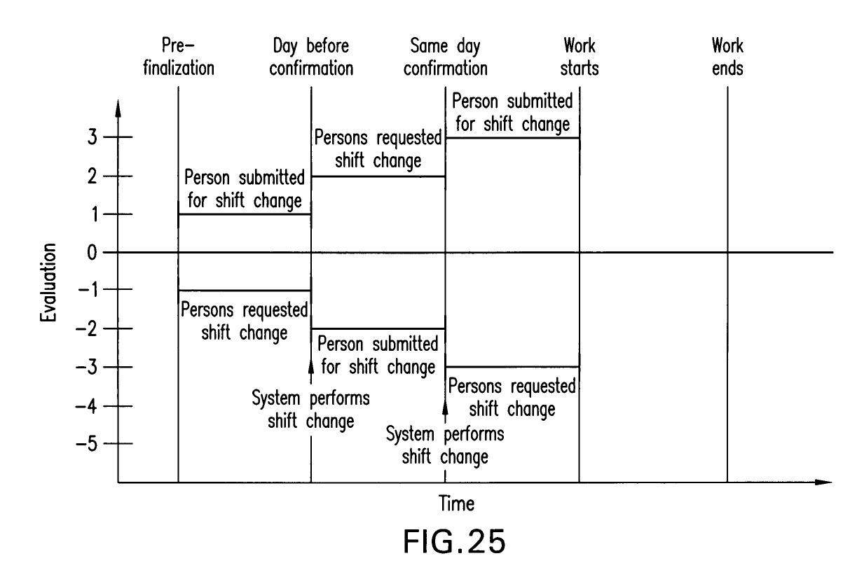

Next, evaluations for attendance will be explained. FIG. 25 shows an example of attendance evaluation, and the horizontal axis indicates evaluation points and the lateral axis indicates time. In this example evaluation, evaluations are made in five stages on the time axis, “provisionally finalized”, “prior day confirmation”, “same day confirmation” “work start”, “work end”. From shift confirmation of step 16 in FIG. 19A, a “1” is assigned to staff who complied with a shift change in place of the relevant staff in the time from the shift finalization and prior day confirmation, and for a person for whom a shift change was requested, a “−1” is assigned. When a system change has occurred in prior day confirmation, for staff complying with the shift change, an evaluation of “2” is assigned, and for a person for whom the shift change was requested, a “−2” is assigned. If a shift change has arisen on the same day confirmation, a “3” is assigned to staff that complied with the shift change, and a “−3” evaluation is assigned to the person who applied for a shift change.

The present invention is for use not only in managing part-time jobs and temporary work at family restaurants, convenience stores and the like, but also in the inn and hotel industry, where if the number of days in a stay, the number of guests, requests and so on, are set, then rooms can be automatically assigned for example, also the system could be used for assigning staff work, and can be applicable in systems relating to schedules and timetables or in a reservation system for spectator seats at a stadium for soccer, etc.

1. A career development system in which a registrant communication terminal carried by a registrant, an employer-end communication terminal, and a system server computer are connected via a communication network such as the Internet and the system server computer automatically assigns persons satisfying conditions for employment in time blocks (cells) corresponding to each duty on a day-to-day basis,
such system server computer comprising:
storage means for storing employment requirements such as the number of persons being recruited, work period, work time blocks, and duties presented by an employer, as well as for storing persons who have registered in advance and such persons' prior work evaluation values; and
cell assignment conditions input means for registering requirements for a cell;
personnel assignment conditions input means for setting at least employment type;
shift frame creation means for designating and registering a work period in order to create shifts corresponding to the employment requirements;
cell creation means for adding created cells to shifts, having a cell creation screen for inputting cell conditions such as time block, number of people, position, employment type, and range of work evaluation values for each duty for each day of a work period registered in a shift frame created by shift frame creation means;
shift creation means for automatically assigning persons to cells made to correspond to each duty for each day based on personnel assignment conditions and work evaluation data relating to such persons, having a shift creation screen in which cells for each duty created for each of a work period by cell creation means are arranged in accordance with the set cell assignment conditions; and
entry means for, after the cells for each duty in accordance with each day of a work period have been created by shift creation means, posting shifts for each duty via a registrant's registered communication terminal and recruiting for a fixed period; and
shift advance confirmation means for communicating to a person given an assignment by shift creation means an advance confirmation response via the registrant's terminal through a communications network and for receiving an advance confirmation response from the assigned person via the registrant's communication terminal,
wherein, after the deadline for recruitment of a specific period set by entry means, shift creation means automatically assigns to the cell a person recruited based on a prior work evaluation value relating to the person recruited and employment requirements.

2. A career development system of claim 1 wherein shift creation means makes assignments starting with persons who satisfy requirements with a high priority order registered in cells set by cell assignment condition input means.

3. A career development system of claim 1 wherein, in those cells having a high assignment priority order from among the cells set by cell assignment condition means, shift creation means makes assignments starting with persons who satisfy requirements with a high priority order registered in such cells.

4. A career development system of claim 2 wherein the priority order for shifts is in accordance with the urgency and importance of the duty.

5. A career development system of claim 2 wherein cell requirement priority order is in the order of the highest work evaluation value first.

6. A career development system of claim 1 wherein if there is overlap of a plurality of persons in the same cell, persons are assigned in the order of highest work evaluation value.

7. A career development system of claim 1 wherein storing means stores reservation patterns agreed upon by staff and employer in which employment requirements under which work is possible are entered in advance, and when the condition for assigning personnel is first come, first served, shift creation means applies an entered reservation pattern stored in storing means to a cell and makes automatic assignments in priority order.

8. A career development system of claim 7 wherein when, after cells for each duty are created by cell creation means, a reservation pattern is applied and priority cells are designated, shift creation means makes automatic assignment of reservation patterns to cells in priority order, and after pre-posting shift finalization, entry means posts shifts by duty to registrants via their registered communication terminal and recruits staff for a set period.

9. A career development system of claim 1 wherein, if an open cell arises following automatic assignment of registered persons by shift creation means, entry means posts a shift for the duty of the open cell to those registered persons who have not been automatically assigned, and recruits again for a set period; after the deadline, shift creation means automatically assigns applicants to the empty cells based on advance work evaluation values of the applicants and employment requirements.

10. A career development system in which a registrant communication terminal carried by a registrant, an employer-end communication terminal, and a system server computer are connected via a communication network such as the Internet, and the system server computer posts duties with employment requirements that the employer has presented, such as the number of persons to recruit, work period, work time blocks, and duties, to registrants' communication terminals, recruitment is carried out for a set time and, after the recruitment period deadline, automatic assignment is made of applicants to time blocks (cells) corresponding to each duty for each day based on advance work performance evaluation values relating to the applicants and the employment requirements, such system server computer comprising:
cell assignment condition input means for registering cell requirements and setting the priority order of the registered requirements;
personnel assignment condition input means for setting at least the employment type order;
shift frame creation means for designating and registering a work period in order to create shifts matching the employment requirements;
cell creation means for adding created cells to shifts, having a cell creation screen for inputting cell conditions such as time block, number of people, employment type, and range of work performance evaluation values for each duty of each day of a work period registered in a shift frame created by shift frame creation means;
shift creation means for automatically assigning persons to cells in accordance with the set cell assignment conditions, having a shift creation screen in which cells for each duty created for each day of a work period by cell creation means are arranged in accordance with the set cell assignment conditions; and
shift advance confirmation means for notifying persons assigned by shift creation means of an advance confirmation response of a duty to an applicant's communication terminal via a communications network, and for receiving an advance confirmation response via an registrant's communication terminal from the assigned person.

11. A career development system of claim 10 wherein, when advance confirmation means receives communication from an assigned person, through an advance confirmation response, of an application for a change to a substitute person that the assigned person found himself (community shift change), shift creation means compares the advance work performance evaluation value relating to the substitute person with the work performance evaluation value set by the cell conditions, and determines whether the person is appropriate.

12. A career development system of claim 10 wherein, if shift advance confirmation means determines that none of the assigned persons sent an advance confirmation response, shift creation means, in accordance with personnel assignment conditions, makes automatic assignment of another person to the relevant cell (system shift change), and shift confirmation means notifies such other person of the assignment through such person's registrant communication terminal.
